(19) United States
(12) Patent Application Publication
(10) Pub. No.: US 2025/0124819 A1
(43) Pub. Date: Apr. 17, 2025

(54) Demonstration Toilet System

(71) Applicant: Washington Suburban Sanitary Commission, Laurel, MD (US)

(72) Inventors: James Haldeman, Laurel, MD (US); Carroll Matthews, Laurel, MD (US); Christin Patterson, Laurel, MD (US); David Gibson, Laurel, MD (US)

(21) Appl. No.: 18/918,947

(22) Filed: Oct. 17, 2024

Related U.S. Application Data
(60) Provisional application No. 63/590,969, filed on Oct. 17, 2023.

(51) Int. Cl. G09B 25/00

(52) U.S. Cl. CPC G09B 25/00

(57) ABSTRACT

A system includes a toilet or structure representative of at least a portion thereof. The toilet or structure representative of at least a portion thereof includes at least one component that is configured to leak. The system further includes a fluid circuit having a pump that is configured to circulate water through the toilet or structure representative of at least a portion thereof. A flow meter in communication with the fluid circuit is configured to measure flow through the fluid circuit.

### CROSS-REFERENCE TO RELATED APPLICATION

This application claims priority to and the benefit of the filing date of U.S. Provisional Patent Application No. 63/590,969, filed Oct. 17, 2023, the entirety of which is incorporated by reference herein.

### FIELD

This disclosure is directed to demonstration toilets and, in particular, to demonstration toilets that simulate leaks.

### BRIEF DESCRIPTION OF THE DRAWINGS

FIG. 1 illustrates an exemplary demonstration toilet system as disclosed herein.

FIG. 2 illustrates a toilet of the exemplary demonstration toilet system of FIG. 1, showing features for internal leak simulation.

FIG. 3 shows components for circulating water in the exemplary demonstration toilet system of FIG. 1.

FIG. 4 shows exemplary lighting for the toilet of FIG. 1.

FIG. 5 shows an exemplary water meter display.

FIG. 6 shows an exemplary digital display.

FIG. 7 shows features for transporting the exemplary demonstration toilet system of FIG. 1.

FIG. 8 is a perspective view of an exemplary demonstration toilet system as disclosed herein.

FIG. 9 is a perspective view of the exemplary demonstration toilet system of FIG. 8, with an equipment door open to see interior components.

### DETAILED DESCRIPTION

The present invention can be understood more readily by reference to the following detailed description, which include examples, drawings, and claims. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” can include both singular and plural referents unless the context clearly dictates otherwise. Thus, for example, unless the context dictates otherwise, reference to “a pump” can represent disclosure of embodiments that include only a single pump, as well as disclosure of embodiments that include two or more such pumps.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

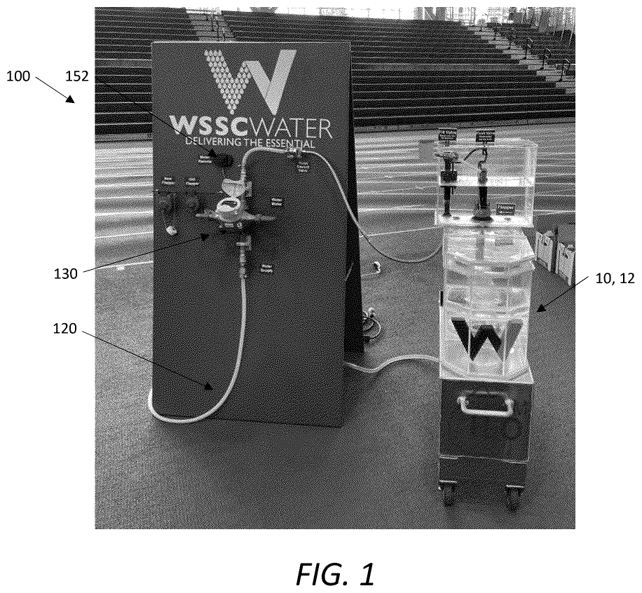

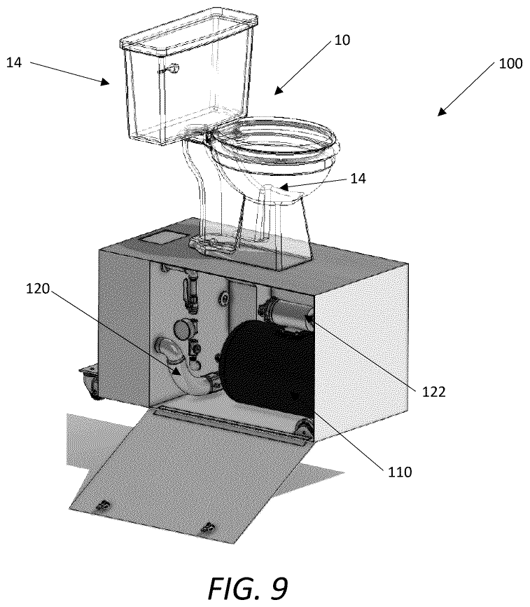

Disclosed herein, in various aspects, and with reference to FIGS. 1-9 is a demonstration toilet system 100. The demonstration toilet system can comprise a toilet 10 or a structure 12 representative of at least a portion of a toilet. For example, in some aspects, the system 10 can comprise an off-the-shelf toilet. The off-the-shelf toilet can be the toilet 10. In other aspects, the system 10 can comprise a structure 12 that is representative of a toilet. The structure 12 representative of the toilet can comprise, for example, a tank 14 and a bowl 16. The structure 12 representative of the toilet can comprise can further comprise componentry that forms the inner workings of a toilet. For example, the componentry that forms the inner workings of the toilet can comprise one or more of: a fill valve 20; a flapper 22; a handle 24; or a coupling 26 between the handle and the flapper. The fill valve 20 can be configured to selectively permit water into the tank 14 from a water supply 110. For example, the fill valve 20 can comprise a float that floats on water in the tank to close the fill valve upon a water level in the tank reaching a threshold height. The flapper 22 can selectively permit flow from the tank 14 to the bowl 16. The coupling 26 between the handle and the flapper can comprise lever arm 28 and a chain 30 (or other flexible coupling) coupled to, and extending between a distal end of the lever arm 28 and the flapper 22. In various aspects, portions of the toilet (or structure representative of the toilet) can be omitted. For example, the toilet 10 (or structure 12 representative of the toilet) can omit a toilet seat.

The toilet or structure representative of at least a portion thereof can be arranged to leak. For example, at least one component can be configured to leak. In some aspects, the at least one component that is configured to leak can be intentionally modified from an off-the-shelf form to leak. In other aspects, the at least one component can comprise a component that has degraded over time due to use.

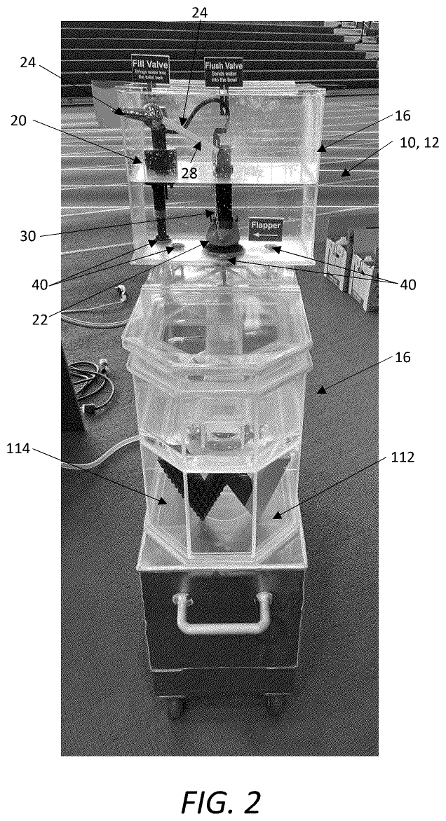

In some aspects, and with reference to FIG. 2, the at least one component that is configured to leak can comprise a component that is configured to simulate an internal leak. Optionally, in these aspects, the toilet or structure representative of a toilet can comprise one or more valves or seals that are selectively movable to a condition that simulates or represents an internal leak condition. That is, the componentry that forms the inner workings of the toilet can be configured to leak. For example, the flapper 22 can be cut or otherwise modified not to form a seal with between the tank and the bowl. As another example, the chain 30 of the coupling 26 can be shortened to inhibit sealing of the flapper 22. As another example, the fill valve 20 can be modified to leak.

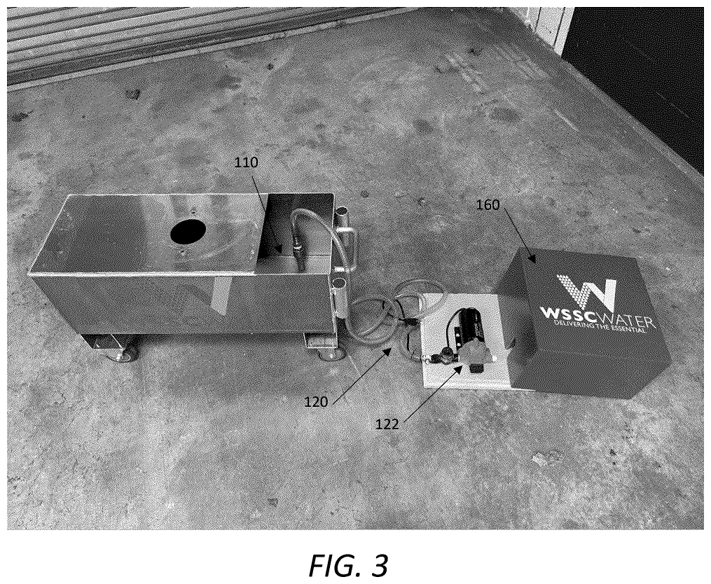

In some aspects, and with reference to FIG. 3, the at least one component that is configured to leak can comprise a component that is configured to simulate an external leak. Optionally, in these aspects, the toilet or structure representative of a toilet can comprise one or more seals 40 or valves that are configured to provide an external leak. For example, the one or more seals 40 or valves can be selectively movable to a condition that simulates or represents an external leak condition.

The demonstration toilet system 100 can comprise the water supply 110. In some aspects, the demonstration toilet 100 can comprise a fluid circuit 120 comprising a pump 122 that is configured to circulate water through the toilet or structure representative of at least a portion thereof. For example, flow leaving the toilet bowl can be pumped via the pump to the water supply 110. In some aspects, the water supply 110 can be a basin that is elevated relative to the tank 14 to permit gravitational flow into the tank as regulated by the fill valve 20. In other aspects, the pump 122 can generate pressure to provide water pressure to the fill valve. Optionally, in these aspects, the water supply 110 can be provided below the toilet 10.

The demonstration toilet system 100 can further comprise a flow meter 130 in communication with the fluid circuit 120. The flow meter 140 can be configured to measure flow through the fluid circuit 130.

The demonstration toilet system 100 can further comprise a display 140 that is configured to provide a readout indicative of flow through the fluid circuit. In some aspects, the display 140 can be or can include an analog indicator. In other aspects, the display 140 can be or can include a digital display.

The demonstration toilet system 100 can further comprise a computing device 150 that is configured to calculate at least one metric associated with the flow through the fluid circuit. The at least one metric associated with the flow through the fluid circuit can comprise, for example, an operational cost. Accordingly, the demonstration toilet system can demonstrate the costs of a leaking toilet. The cost can be a function the amount of water leaking from the toilet over an amount of time (e.g., as measured by the flow meter 130), multiplied by the unit cost of water.

In some aspects, the system can comprise an input device 152, such as, for example, a keyboard, mouse, touchscreen, or wireless receiver that is configured to communicate with an external device such as a smartphone or tablet. The input device 152 can be configured to receive a user input to select at least one parameter associated with the flow through the fluid circuit. For example, the at least one parameter associated with the flow through the fluid circuit comprises a cost per unit of water flow.

In some aspects, the at least a portion of the toilet or structure representative of at least a portion thereof can be transparent. For example, in these aspects, substantially an entirety of the toilet or structure representative of at least a portion thereof can be transparent. Accordingly, in some aspects, the toilet 10 can comprise transparent polymer. For example, at least the bowl 16 and the tank 14 can be transparent. In some aspects, at least 50%, at least 60%, at least 70%, at least 80%, at least 90%, or all, or substantially all of the toilet 10 or structure 12 can be transparent. In some aspects, at least 50%, at least 60%, at least 70%, at least 80%, at least 90%, or all, or substantially all of the tank 14 can be transparent. In some aspects, at least 50%, at least 60%, at least 70%, at least 80%, at least 90%, or all, or substantially all of the bowl 16 can be transparent. Optionally, in the above examples specifying portions of the toilet 10 or structure 12 that are transparent, it is contemplated that the stated percentages and portions of the toilet or structure that are transparent can refer to surface areas defined by the outer surfaces of said toilet or structure.

The disclosed toilet or structure representative of at least a portion thereof can be a transparent representation of a working toilet. The toilet 10 or structure 12 can optionally be provided in conjunction with a water meter demonstration and pumped water circulation system. The system 100 can be designed to demonstrate the functionality and failure modes of a working toilet as a completely independent system configuration-without any need to be connected to an external water source. The clear demonstration toilet system can optionally be completely transparent thus allowing all internal components, waterways, and flow paths to be seen by an audience. Additionally, by designing the toilet and apparatus to function independent of a water source (i.e. connection to municipal water supply), this system is highly transportable for demonstration purposes at venues (exposition halls, community events, conferences, etc.).

The system 100 can provide the ability for an individual to manually simulate the common internal leaks found in a toilet. The common internal leaks found in a toilet are as follows: 1) a running leak in the flush valve due to a faulty flapper; 2) a running leak in the flush valve due to a stuck flapper chain; 3) an overflow leak in the overflow tube due to a stuck/punctured fill valve float; 4) an overflow leak in the overflow tube due to a faulty fill valve. The toilet 10 can be configured to simulate one or more of these four (4) common leaks. For example, the toilet can comprise mechanical linkages that connects necessary components within the toilet to handles on the top of the toilet. One or multiple leaks can be simulated at one time. Upon actuation of a leak, water can begin to flow from the toilet tank to the toilet bowl. The transparency of the toilet material allows for the flow of water, and the change in water level in the toilet tank and bowl to be visible by the audience. Furthermore, due to the transparency of the toilet material and the method in which the leaks are actuated, simulation or representation of all of these common leaks can be performed without any manipulation or disassembly of the demonstration toilet from a toilet's normal configuration. Each of the above mentioned internal leaks is shown in FIG. 2.

External leaks can also be simulated on the demonstration toilet. An external leak can be defined as a leak in which water leaks from inside of the toilet to the outside of the toilet. On a typical toilet, these types of leaks would flow to the floor of a bathroom and could lead to water damage or flooding of a residence/business. The toilet 10 can simulate these leaks without losing water outside of the demonstration toilet system. This can be achieved by integrating a catch basin 112 having at least one wall 114 below the toilet that directs any leaks into the water supply 110 of the system. This is a benefit for demonstration purposes because no water that leaks from an external leak will escape the system and end up on the floor of a venue space. External leaks of a toilet that can be simulated by this system are as follows: 1) toilet tank to toilet bowl bolt hole leaks; 2) flush valve seal leak; 3) fill valve seal leak; and/or 4) toilet bowl floor seal leak. Each of the above-mentioned external leak locations and location of the catch basin are shown in FIG. 2.

The fluid circuit 120 of the system 100 can comprise a storage tank (e.g., water supply 140) that is optionally integral to the transparent toilet. The storage tank can hold sufficient volume of water for the entire demonstration system to work correctly and prevent the need for external water source. The system also includes a circulating water pump that provides water flow and pressure equivalent to that of a residence or business. This can simulate realistic water loss flow rate within the system. A weighted water pickup component can be incorporated into the storage tank to ensure that the pumped water circulation system does not ingest air into the system. The pickup component can also contain a backflow prevention valve that eliminates cavitation in through the circulation system. The ability to prevent air ingestion and/or cavitation is critical to providing a smooth-running circulation system and ensures accurate water meter measurements. The pumped water circulation system can comprise a soundproof enclosure 160 to minimize pump noise heard from the audience. The components of an exemplary pumped water circulation system are shown in FIG. 3.

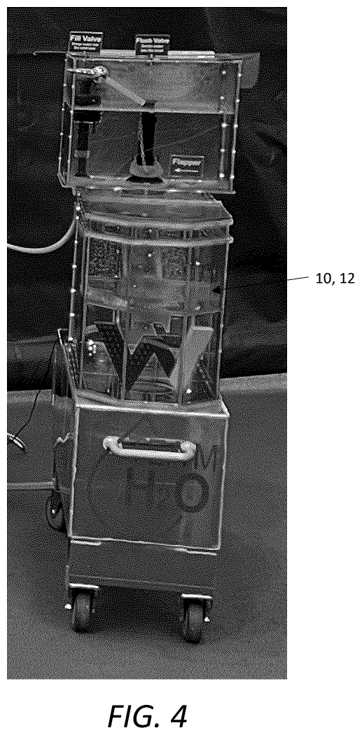

The system 100 can be configured to provide an audience with the best visual understanding of toilet leaks. Waterproof lighting is provided within the toilet to illuminate the toilet components and enhance the view of water flow through the toilet. The lighting can be configured to illuminate a level of water in the toilet. The lighting also serves as an attention-grabbing feature that draws the attraction of the audience from across the venue space and makes the toilet demonstration more appealing to the audience. Exemplary lighting of an illuminated toilet is shown in FIG. 4.

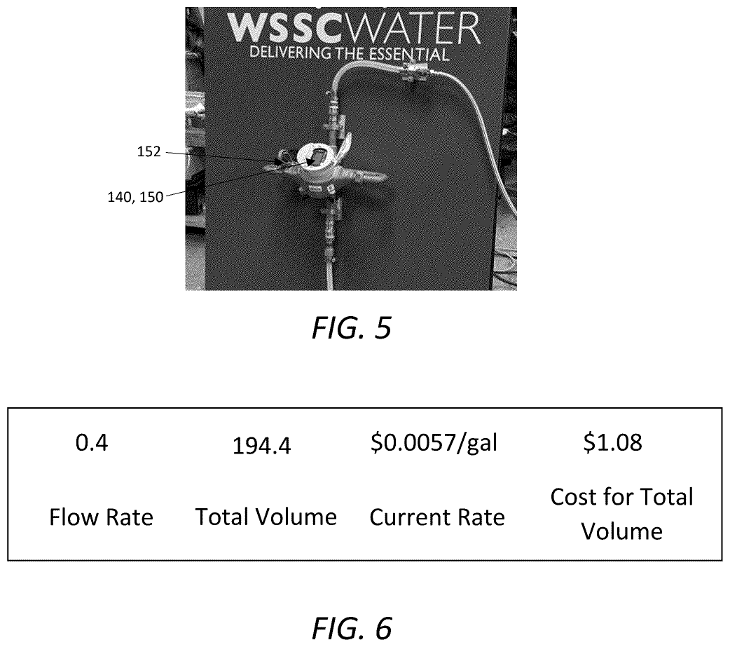

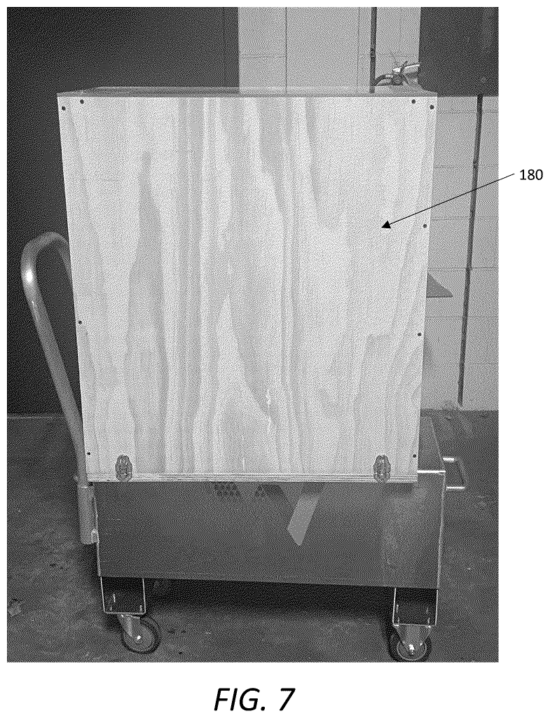

Providing a live display of water use due to failed or malfunctioning toilet components can allow an individual to fully understand the magnitude of a leak over time. A leaking component may appear small and insignificant, however by displaying the flow rate, total volume and cost associated with the leak, a customer can have a better grasp of the impact. To provide this, the system 100 can feature a water meter representative of those familiar to the individual with live water flow display. The live water display on the water meter screen can show instantaneous water flow (e.g., in gallons). The water meter can be mounted on a portable stand that brings the live water display to a height easily viewed by the average customer's height. The accuracy of the water meter display can be one-tenth of a gallon per minute, therefore even the smallest simulated leak(s) can show a value on the water meter display. A second system display can provided to show instantaneous flow rate, total volume, current rate per volume and cost of total volume side-by-side. The display can be programmable to display in English and/or SI units, can be reset (zeroed-out) at any time and has the ability to adjust the cost per unit of water volume (gallon, liters, etc.) based on a utility's current rate. FIGS. 5 and 6 show an exemplary water meter and layout of the system display.

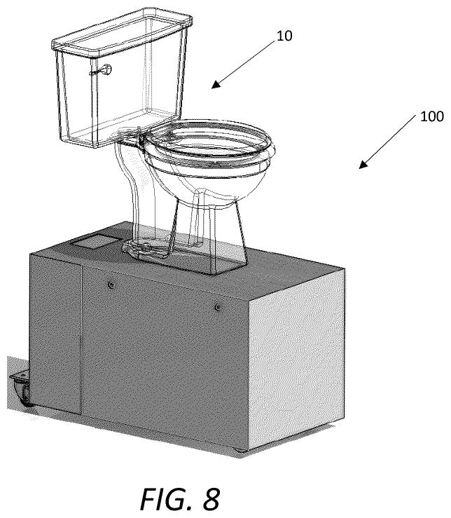

The system 10 can include a travel case 180 to protect the toilet during transportation from storage to the venue. The travel case can include wheels and a push handle that can be used once the system arrives at the venue and needs to be pushed to its final location. Hand holds can also be included in the system so that lifting off a truck/vehicle can be performed in a safe, ergonomic manner. FIG. 8 shows an exemplary travel case and above-mentioned travel features.

Although several embodiments of the invention have been disclosed in the foregoing specification and the following appendices, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A system comprising:
a toilet or structure representative of at least a portion thereof, wherein the toilet or structure representative of at least a portion thereof comprises:
a tank; and
at least one component that is configured to leak;
a fluid circuit comprising a pump that is configured to pump water to the tank; and
a flow meter in communication with the fluid circuit, wherein the flow meter is configured to measure flow through the fluid circuit.

2. The system of claim 1, wherein the at least one component that is configured to leak comprises a component that is configured to simulate an external leak.

3. The system of claim 2, wherein the component that is configured to simulate the external leak is a seal.

4. The system of claim 2, further comprising:
a water supply, wherein the pump is configured to pump water from the water supply to the tank; and
at least one wall that is configured to direct flow from the component that is configured to simulate the external leak to the water supply.

5. The system of claim 1, wherein the at least one component that is configured to leak comprises a component that is configured to simulate an internal leak.

6. The system of claim 2, wherein the component that is configured to simulate the internal leak is one of a flapper or a fill valve.

7. The system of claim 1, further comprising a display that is configured to provide a readout indicative of flow through the fluid circuit.

8. The system of claim 7, wherein the display is a digital display.

9. The system of claim 7, further comprising a computing device that is configured to calculate at least one metric associated with the flow through the fluid circuit.

10. The system of claim 9, wherein the at least one metric associated with the flow through the fluid circuit comprises an operational cost.

11. The system of claim 9, further comprising an input device, wherein the input device is configured to receive a user input to select at least one parameter associated with the flow through the fluid circuit.

12. The system of claim 11, wherein the at least one parameter associated with the flow through the fluid circuit comprises a cost per unit of water flow.

13. The system of claim 1, wherein the at least one component that is configured to leak is modified from an off-the-shelf form to leak.

14. The system of claim 1, wherein at least a portion of the toilet or structure representative of at least a portion thereof is transparent.

15. The system of claim 14, wherein the toilet or structure representative of at least a portion thereof further comprises a bowl, wherein each of the tank and bowl is transparent.

16. The system of claim 11, wherein 80% of a surface area of the toilet or structure representative of at least a portion thereof is transparent.

17. The system of claim 1, further comprising a water supply, wherein the pump is configured to pump water from the water supply to the tank.

18. The system of claim 17, wherein the water supply is self-contained within the system.

19. The system of claim 17, wherein the water supply is not in fluid communication with a water source of a building or municipal water supply.

20. The system of claim 1, further comprising lighting that is configured to illuminate a level of water in the toilet or structure representative of at least a portion thereof.
